(19) United States
(12) Patent Application Publication
(10) Pub. No.: US 2017/0075471 A1
(43) Pub. Date: Mar. 16, 2017

(54) DISPLAY DEVICE INTEGRATED WITH TOUCH SCREEN, AND METHOD OF MANUFACTURING THE SAME

(71) Applicant: Samsung Display Co., Ltd., Yongin-si (KR)

(72) Inventors: Sung Jin HONG, Yongin-si (KR); Jae Byung PARK, Yongin-si (KR); Hyun Deok IM, Yongin-si (KR); Hyun Min CHO, Yongin-si (KR); Jae Woong KANG, Yongin-si (KR); Jong Hyuk KANG, Yongin-si (KR); Dae Hyun KIM, Yongin-si (KR); Joo Yeol LEE, Yongin-si (KR)

(21) Appl. No.: 15/186,214

(22) Filed: Jun. 17, 2016

(30) Foreign Application Priority Data
Sep. 10, 2015 (KR) 10-2015-0128615

(51) Int. Cl. G06F 3/041; G02F 1/1333; G02F 1/1343; G02F 1/1335; G06F 3/044; G02F 1/1368

(52) U.S. Cl. CPC G06F 3/0416; G06F 3/044; G06F 3/0412; G02F 1/1368; G02F 1/134309; G02F 1/133528; G02F 1/13338; G02F 1/133345; G02F 1/133514; G06F 2203/04102; G06F 2203/04103; G06F 2203/04111; G02F 2001/133548; G02F 2202/36

(57) ABSTRACT

A display device integrated with a touch screen, including: a first base substrate including a plurality of pixel areas; a second base substrate facing the first base substrate; a thin film transistor disposed on the first base substrate; a first electrode connected with the thin film transistor; a second electrode facing the first electrode on the second base substrate and including a plurality of patterns spaced apart from each other by a predetermined distance in a column direction; and a conductive pattern disposed between the second base substrate and the second electrode, and including a plurality of patterns spaced apart from each other by a predetermined distance in a row direction crossing the column direction. Each of the plurality of patterns provided in the conductive pattern includes a plurality of fine patterns formed of a wire grid polarizer and a metal pattern disposed around the plurality of fine patterns.

### CROSS-REFERENCE TO RELATED APPLICATION

This application claims priority to and the benefit of Korean Patent Application No. 10-2015-0128615, filed on Sep. 10, 2015, in the Korean Intellectual Property Office, the entire contents of which are incorporated herein by reference in their entirety.

### BACKGROUND

Field

The present disclosure relates to a display device integrated with a touch screen and a method of manufacturing the same.

Discussion of the Background

A display device, which is widely used in a mobile device and the like, has generally adopted a method of using a general interface device, such as a keyboard and a remote control device, that enables a user to select a predetermined object or area displayed on a screen, and a touch screen integration method that enables a user to directly select and input an area of a screen by using a finger, a stylus pen, or the like.

An implementation method of the touch screen integrated display device generally includes a structure in which a touch screen for detecting a touch is separately provided from and attached onto a display panel, or an in-cell structure in which a touch electrode and wires are formed on a substrate of a display panel to be implemented as one panel. Generally, the touch screen integrated display device to which the in-cell structure is applied has a sensitive touch sense and a simplified manufacturing process.

The touch screen integrated display device includes touch electrodes and touch wires for sensing a touch, and a manufacturing process for forming the touch electrodes and the touch wires is added.

Accordingly, various research for simplifying a manufacturing process and reducing manufacturing cost has been conducted.

### SUMMARY OF THE DISCLOSURE

The present disclosure provides a display device integrated with a touch screen and a simplified method of manufacturing the same.

An exemplary embodiment of the present disclosure provides a display device integrated with a touch screen, including: a first base substrate including a plurality of pixel areas; a second base substrate facing the first base substrate; a thin film transistor disposed on the first base substrate; a first electrode connected with the thin film transistor; a second electrode facing the first electrode on the second base substrate and including a plurality of patterns spaced apart from each other by a predetermined distance in a column direction; and a conductive pattern disposed between the second base substrate and the second electrode, and including a plurality of patterns spaced apart from each other by a predetermined distance in a row direction crossing the column direction, in which each of the plurality of patterns provided in the conductive pattern includes a plurality of fine patterns formed of a wire grid polarizer and a metal pattern disposed around the plurality of fine patterns.

In the embodiment, the second electrode may be configured to receive a common voltage during an image display period of the plurality of pixel areas, and receive a touch driving signal during an image non-display period of the plurality of pixel areas.

In the embodiment, the conductive pattern may include an opaque conductive material.

In the embodiment, the plurality of fine patterns may overlap the pixel area.

In the embodiment, the metal pattern may overlap the thin film transistor.

In the embodiment, the display device may further include an insulating layer disposed between the second electrode and the conductive pattern.

In the embodiment, the insulating layer may comprise any one selected from an inorganic insulating material and an organic insulating material.

In the embodiment, the display device may further comprise: a liquid crystal layer disposed between the first electrode and the second electrode; and a color filter layer disposed under the liquid crystal layer on the first base substrate and configured to emit light of a specific color by filtering light passing through the first base substrate.

In the embodiment, the display device may further comprise: a liquid crystal layer disposed between the first electrode and the second electrode; and a color filter layer disposed between the conductive pattern and the second base substrate on the second base substrate.

The color filter layer may comprise a quantum dot.

Another exemplary embodiment of the present disclosure provides a method of manufacturing a display device integrated with a touch screen, the method including: providing a first base substrate including a plurality of pixel areas and one or more thin film transistors formed in each of the plurality of pixel areas; forming a first electrode connected with the thin film transistor on the first base substrate; providing a second base substrate facing the first base substrate; forming a conductive pattern including a plurality of patterns spaced apart from each other by a predetermined distance in a row direction on the second base substrate; and forming a second electrode facing the first electrode on the conductive pattern and including a plurality of patterns spaced apart from each other by a predetermined distance in a column direction crossing the row direction, in which each of the plurality of patterns provided in the conductive pattern includes a plurality of fine patterns formed of a wire grid polarizer and a metal pattern positioned around the plurality of fine patterns.

In the embodiment, the conductive pattern may comprise an opaque conductive material.

In the embodiment, the plurality of fine patterns may overlap the pixel area.

In the embodiment, the metal pattern may overlap the thin film transistor.

In the embodiment, the method may further comprise forming an insulating layer between the second electrode and the conductive pattern.

In the embodiment, the insulating layer may comprise any one selected from an inorganic insulating material and an organic insulating material.

In the embodiment, the second electrode may comprise a transparent conductive material.

As described above, according to the exemplary embodiments of the present disclosure, the conductive pattern including the wire grid polarizer is utilized as the touch receiving electrode Rx during the image non-display period, and the common electrode is utilized as the touch driving electrode Tx, so that it is possible to form a touch electrode without a separate additional mask process within the display device, thereby simplifying a manufacturing process.

### BRIEF DESCRIPTION OF THE DRAWINGS

Example embodiments are now described more fully hereinafter with reference to the accompanying drawings; however, they may be embodied in different forms, and the scope of the present disclosure is not limited to the embodiments set forth herein. Rather, these embodiments are provided to help convey the scope of the example embodiments to those skilled in the art.

In the drawing figures, dimensions may be exaggerated for clarity of illustration. When an element is referred to as being “between” two elements, it may be the only element between the two elements, or one or more intervening elements may also be present. Like reference numerals refer to like elements throughout.

FIG. 1 is a schematic top plan view of a touch screen integrated display device including a touch receiving electrode and a touch driving electrode according to an exemplary embodiment of the present disclosure.

FIG. 2 is an enlarged view of a portion A1 in FIG. 1.

FIG. 3 is a cross-sectional view taken along line I-I′ of FIG. 2.

FIGS. 4, 5, 6, 7, 8, 9, 10, 11 and 12 are cross-sectional views sequentially illustrating a manufacturing process of the touch screen integrated display device of FIG. 3.

### DETAILED DESCRIPTION

Other detailed matters of the exemplary embodiments are included in the detailed description and the drawings.

Various advantages and features of the present disclosure and methods accomplishing thereof will become apparent from the following detailed description of exemplary embodiments with reference to the accompanying drawings.

However, the present disclosure is not limited to the exemplary embodiments set forth below, and may be embodied in various other forms. The present exemplary embodiments are provided to facilitate the understanding of the present disclosure by a person with ordinary skill in the technical field to which the present disclosure pertains. Like reference numerals indicate like elements throughout the specification and drawings.

The size and thickness of the components shown the drawings are optionally determined for better understanding and ease of description, and the present disclosure is not limited to the examples shown in the drawings. That is, thicknesses are enlarged or exaggerated to clearly express various portions and areas. When an element such as a layer, film, region, or substrate is referred to as being “on” another element, it may be directly on the other element, or intervening elements may also be present.

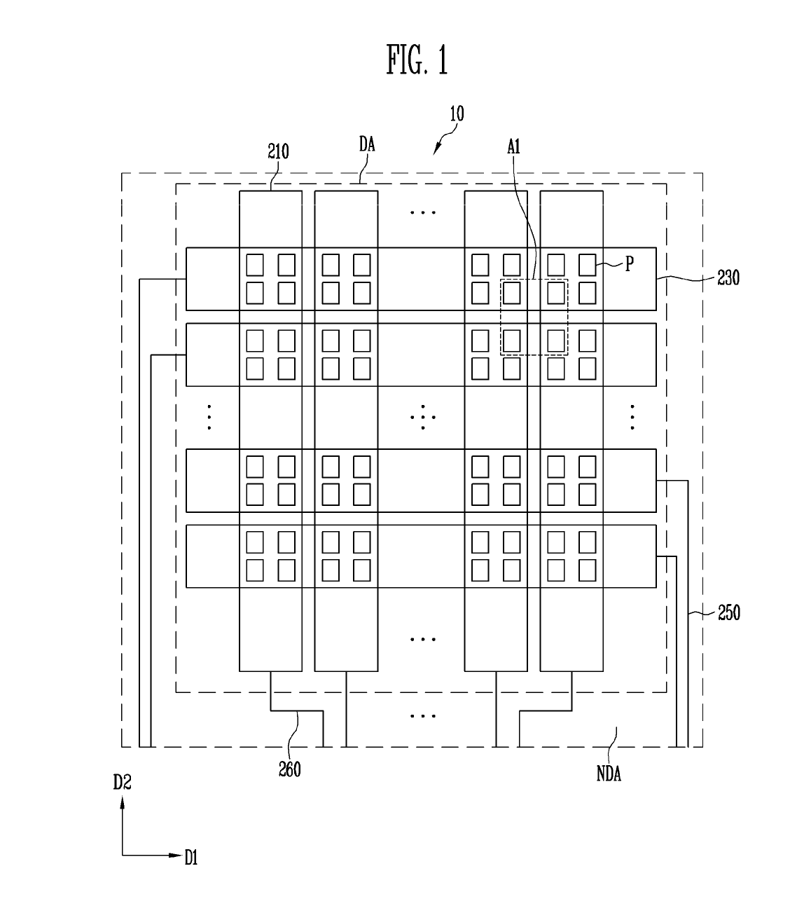

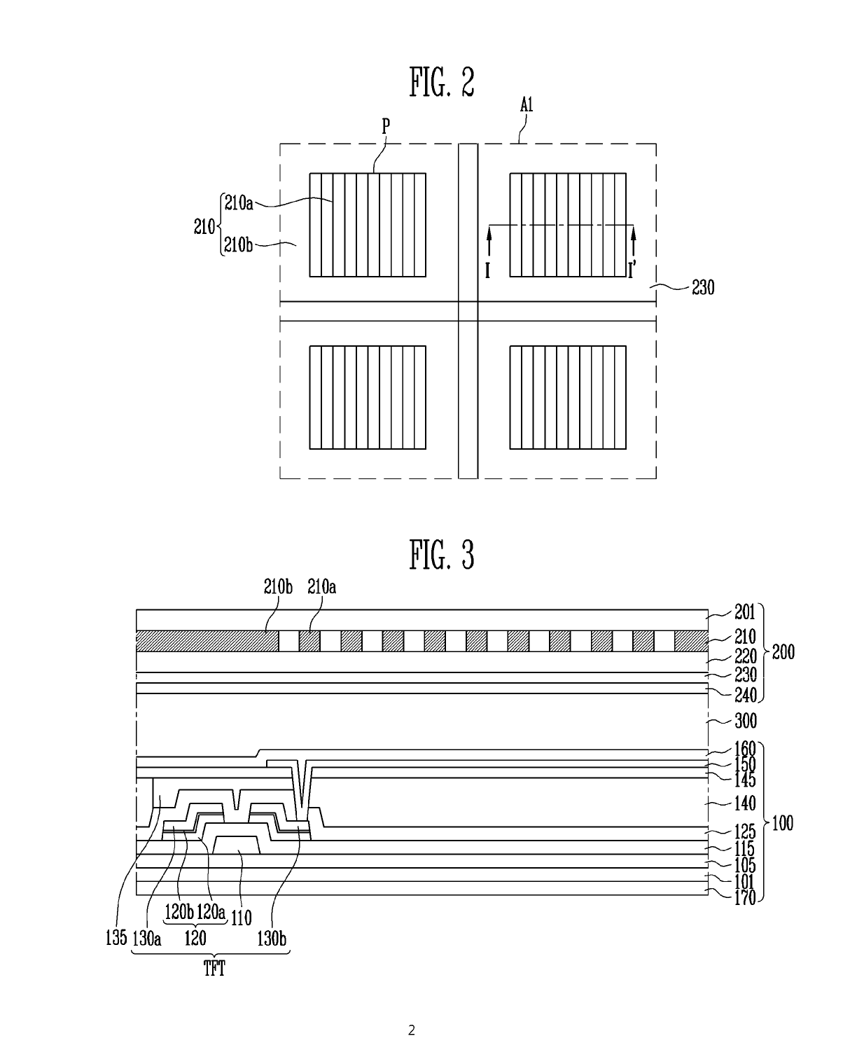

FIG. 1 is a schematic top plan view of a touch screen integrated display device including a touch receiving electrode and a touch driving electrode according to an exemplary embodiment of the present disclosure. FIG. 2 is an enlarged view of a portion A1 in FIG. 1. FIG. 3 is a cross-sectional view taken along line I-I′ of FIG. 2.

Hereinafter, a touch screen integrated display device according to an exemplary embodiment of the present disclosure is described with reference to FIGS. 1 to 3. In the present specification, the embodiments are described based on a touch screen integrated display device including a liquid crystal display device as an example; however, the present disclosure is not limited thereto. For example, an organic light emitting display device in which a touch screen may be integrally used may be applied as the display device.

Referring to FIGS. 1 to 3, a touch screen integrated display device 10 according to an exemplary embodiment of the present disclosure includes a first substrate 100 including a plurality of pixel areas P, a second substrate 200 facing the first substrate 100, and a liquid crystal layer 300 disposed between the two substrates 100 and 200.

The first substrate 100 includes second electrodes 230 extended in a first direction D1, conductive patterns 210 extended in a second direction D2 crossing the first direction D1, and first connection wires 250 connected to the second electrodes 230, and second connection wires 260 connected to the conductive pattern 210.

The second electrode 230 and the conductive pattern 210 are provided in a display area DA of the touch screen integrated display device 10 of the present disclosure.

The first connection wire 250 and the second connection wire 260 are provided in a non-display area NDA surrounding the display area DA. The first connection wire 250 is connected with a driving unit (not illustrated) in the non-display area DNA to provide a common voltage or a touch driving signal to the second electrode 230.

The second connection wire 260 determines whether a touch is generated by providing a detection signal received through the conductive pattern 210 to the driving unit.

The plurality of pixel areas P is provided in areas in which the second electrodes 230 overlap the conductive patterns 210 within the display area DA.

The first substrate 100 includes a first base substrate 101, a thin film transistor TFT formed on the first base substrate 101, a first electrode 150 electrically connected with the thin film transistor TFT, and a first alignment layer 160 formed on the first electrode 150. Here, the thin film transistor TFT includes a gate electrode 110, a semiconductor layer 120, a source electrode 130a, and a drain electrode 130b.

Further, the first substrate 100 further includes a black matrix 135, a color filter 140, and a planarizing layer 145 formed on the thin film transistor TFT. Here, a polarizing plate 170 may be further provided on a rear or bottom surface of the first substrate 100.

Hereinafter, the first substrate 100 is described according to a lamination sequence.

First, the first base substrate 101 is provided. The first base substrate 101 may be a rigid type base substrate and a flexible type base substrate. The rigid type base substrate may be one of an organic base substrate, a quartz base substrate, a glass ceramic base substrate, and a crystalline organic base substrate. The flexible type base substrate may be one of a film base substrate and a plastic base substrate including a polymer organic material. The material applied to the first base substrate 101 may have resistance (or heat resistance) to a high processing temperature during a manufacturing process.

A buffer layer 105 is formed on the first base substrate 101. The buffer layer 105 prevents impurities from being diffused to the thin film transistor TFT. The buffer layer 105 may be formed of a silicon nitride (SiNx), a silicon oxide (SiOx), a silicon oxynitride (SiOxNy), and the like, and may be omitted according to a material and a processing condition of the first base substrate 101.

A gate electrode 110 is formed on the buffer layer 105. The gate electrode 110 may include at least one of nickel, chrome, molybdenum, aluminum, titanium, copper, tungsten, and an alloy thereof. That is, the gate electrode 110 may have a single layer or a multi-layer structure including the metal material. For example, the gate electrode 110 may have a triple-layer structure, in which molybdenum, aluminum, and molybdenum are sequentially laminated. As another example, the gate electrode 110 may have a double-layer structure, in which titanium and copper are sequentially laminated. As yet another example, the gate electrode 110 may have a single-layer structure including an alloy of titanium and copper.

The gate electrode 110 is insulated by a gate insulating layer 115.

A semiconductor layer 120 is formed on the gate insulating layer 115. At least a part of the semiconductor layer 120 may overlap the gate electrode 110. The semiconductor layer 120 may include a semiconductor active layer 120a disposed on the gate insulating layer 115, and an ohmic contact layer 120b disposed on the semiconductor active layer 120a.

The semiconductor active layer 120a may include any one of amorphous silicon (a-Si), polycrystalline silicon (p-Si), and an oxide semiconductor. Here, the oxide semiconductor may include at least one of zinc (Zn), indium (In), gallium (Ga), tin (Sn), and a mixture thereof. For example, the oxide semiconductor may include an indium-gallium-zinc oxide (IGZO).

The ohmic contact layer 120b may have a shape branched from the semiconductor active layer 120a, the source electrode 130a, and the drain electrode 130b. An area between the source electrode 130a and the drain electrode 130b in the semiconductor layer 120 may become a channel portion.

The source electrode 130a and the drain electrode 130b are formed on the semiconductor layer 120. The source electrode 130a and the drain electrode 130b may include at least one of nickel, chrome, molybdenum, aluminum, titanium, copper, tungsten, and an alloy thereof. The source electrode 130a and the drain electrode 130b may be a triple-layer structure, in which molybdenum, aluminum, and molybdenum are sequentially laminated. The source electrode 130a and the drain electrode 130b may be a dual-layer structure, in which titanium and copper are sequentially laminated.

A passivation layer 125 is formed on the source electrode 130a and the drain electrode 130b. The passivation layer 125 may include at least one layer. For example, the passivation layer 125 may include an inorganic passivation layer and an organic passivation layer disposed on the inorganic passivation layer. The inorganic passivation layer may include at least one of a silicon oxide and a silicon nitride. The organic passivation layer may include at least one of acryl, polyimide (PI), polyamide (PA), and benzocyclobutene (BCB). The passivation layer 125 includes an opening exposing a part of the drain electrode 130b to the outside or to other layers.

A black matrix 135 overlapping the thin film transistor TFT and the color filter 140 corresponding to the first electrode 150 are formed on the passivation layer 125.

The planarizing layer 145 for planarization is formed on the black matrix 135 and the color filter 140, and the first electrode 150 electrically connected with the drain electrode 130b is formed on the planarizing layer 145.

The first substrate 100 has a Color Filter on array (COA) structure in which the thin film transistor TFT and the color filter 140 are formed together on the first base substrate 101, or a Black Matrix on Array (BMA) structure in which the thin film transistor TFT and the black matrix 135 are formed together on the first base substrate 101.

The second substrate 200 includes a second base substrate 201, the conductive pattern 210 formed on the second base substrate 201, an insulating layer 220 formed on the conductive pattern 210, the second electrode 230 formed on the insulating layer 220, and a second alignment layer 240 formed on the second electrode 230.

Hereinafter, the second substrate 200 is described according to a lamination sequence.

First, the second base substrate 201 is provided. The second base substrate 201 may be formed of the same material as that of the first base substrate 101.

The conductive pattern 210 is formed on the second base substrate 201. The conductive pattern 210 is formed of a plurality of patterns spaced apart from each other by a predetermined distance in the first direction D1, and each of the plurality of patterns includes a plurality of fine patterns 210a positioned in an area corresponding to the pixel area P and a metal pattern 210b positioned at borders of the plurality of fine patterns 210a.

The plurality of fine patterns 210a and the metal pattern 210b may include the same conductive material.

The plurality of fine patterns 210a and the metal pattern 210b may include a metal material having high reflectivity. For example, the plurality of fine patterns 210a and the metal pattern 210b may include one of aluminum, gold, silver, copper, chrome, iron, nickel, molybdenum, and an alloy thereof.

The plurality of fine patterns 210a and the metal pattern 210b may have a single-layer structure or a multi-layer structure, in which two or more layers of metals are laminated. For example, the plurality of fine patterns 210a and the metal pattern 210b may be a dual-layer structure including a lower layer including aluminum and an upper layer including titanium.

Further, the plurality of fine patterns 210a and the metal pattern 210b may also be a dual-layer structure including a lower layer including aluminum and an upper layer including molybdenum.

The plurality of fine patterns 210a is formed in parallel in the first direction D1 on a surface of the second base substrate 201. The plurality of fine patterns 210a is formed in a stripe form in which adjacent fine patterns are spaced apart by a predetermined distance. The plurality of fine patterns 210a may have a thickness of 150 nm or more, and the interval between the fine pattern 210a and the adjacent fine pattern may be 100 nm or less.

The plurality of fine patterns 210a may serve as a Wire Grid Polarizer (WGP), which allows only specific polarized light in an electromagnetic wave (for example, visible light) to pass through during an image display period of the touch screen integrated display device 10 according to the exemplary embodiment of the present disclosure.

The metal pattern 210b is disposed around the plurality of fine patterns 210a, and overlaps the thin film transistor TFT and the black matrix 135 of the first substrate 100. The metal pattern 210b overlaps the thin film transistor TFT and the black matrix 135 to serve as a light blocking unit that blocks light passing through the thin film transistor TFT from moving to the second substrate 200.

Even though the metal pattern 210b is formed of an opaque conductive material, but because the metal pattern 210b overlaps the thin film transistor TFT and the black matrix 135, the metal pattern 210b does not influence an aperture ratio of the pixel area P.

Further, the metal pattern 210b may serve as a touch receiving electrode, which detects a touch position by providing a detection signal to an external driving unit (not illustrated) through the second connection wire 260 during an image non-display period.

The insulating layer 220 is formed on the conductive pattern 210. The insulating layer 220 may include any one selected from an inorganic insulating material and an organic insulating material. The inorganic insulating material may include at least one of a silicon oxide and a silicon nitride.

The second electrode 230 is formed on the insulating layer 220. The second electrode 230 may be formed of a transparent conductive material. The second electrode 230 may be formed of a conductive metal oxide, such as an indium tin oxide (ITO), an indium zinc oxide (IZO), and an indium tin zinc oxide (ITZO).

The second electrode 230 is implemented by a plurality of patterns spaced apart from each other by a predetermined distance in the second direction D2, and each of the plurality of patterns is electrically connected with the first connection wire 250 to receive a touch driving signal from the first connection wire 250. Accordingly, the second electrode 230 may be used as a touch driving electrode in the touch screen integrated display device 10 according to the exemplary embodiment of the present disclosure.

A common voltage is supplied to the second electrode 230 during an image display period of the touch screen integrated display device 10, and the touch driving signal is provided to the second electrode 230 during an image non-display period of the touch screen integrated display device 10. Accordingly, the second electrode 230 may be used as the common electrode during the image display period, and used as the touch driving electrode during the image non-display period.

Mutual capacitance is formed between the conductive patterns 210 and the second electrode 230 at crossing points of the conductive patterns 210 and the second electrode 230. Thus, each crossing point, at which the mutual capacitance is formed, may be a detection cell recognizing a touch.

The common voltage of a predetermined level is applied to the second electrode 230 during the image display period, and the touch driving signal is supplied to the second electrode 230 during the image non-display period when the touch detection is performed. The touch driving signal is for detecting a touch position, and may be a voltage higher than the common voltage.

When a finger and the like is touched to the detection cell while the touch driving signal is applied, a voltage according to a change in mutual capacitance is detected, and the voltage is provided to the driving unit through the second connection wire 260 connected with the conductive pattern 210 to detect a touch position.

The second alignment layer 240 is formed on the second electrode 230.

As described above, the second electrode 230 serves as both the common electrode and the touch driving electrode in the touch screen integrated display device 10 according to the exemplary embodiment of the present disclosure, and the conductive pattern 210 serves as both a polarizer and the touch receiving electrode.

Accordingly, in the touch screen integrated display device 10 according to the exemplary embodiment of the present disclosure, a mask process for the touch electrode of the touch screen is omitted. That is, the touch electrode is formed within the display device without an additional mask process, thereby simplifying a manufacturing process and decreasing manufacturing cost of the display device.

In the above-discussed embodiment of the touch screen integrated display device 10, although the color filter 140 is formed on the first base substrate 101 together with the thin film transistor TFT, the present disclosure is not limited thereto. For example, the color filter 140 may be formed on the second base substrate 201. In this case, the color filter 140 may be formed of a material in which a photosensitive film material is mixed with a quantum dot that is a fluorescent substance. When the color filter 140 is formed of the quantum dot, the color filter 140 may be disposed between an upper portion of the conductive pattern 210 and the second base substrate 201, which enables light, of which light is finally adjusted, to pass through the color filter 140 because the quantum dot performs circular polarization. Here, the color filter 140 is disposed on the second conductive pattern 210 and may serve as a passivation layer protecting the second conductive pattern 210.

In the present exemplary embodiment, the display device has been described based on the liquid crystal display device, but the present disclosure is not limited thereto. For example, instead of the liquid crystal layer 300 formed between the first substrate 100 and the second substrate 200, the characteristic of the present exemplary embodiment may also be applied to an organic light emitting display device including an organic light emitting layer generating light between the first electrode 150 and the second electrode 230.

Hereinafter, a method of manufacturing the touch screen integrated display device according to an exemplary embodiment of the present disclosure is described in detail.

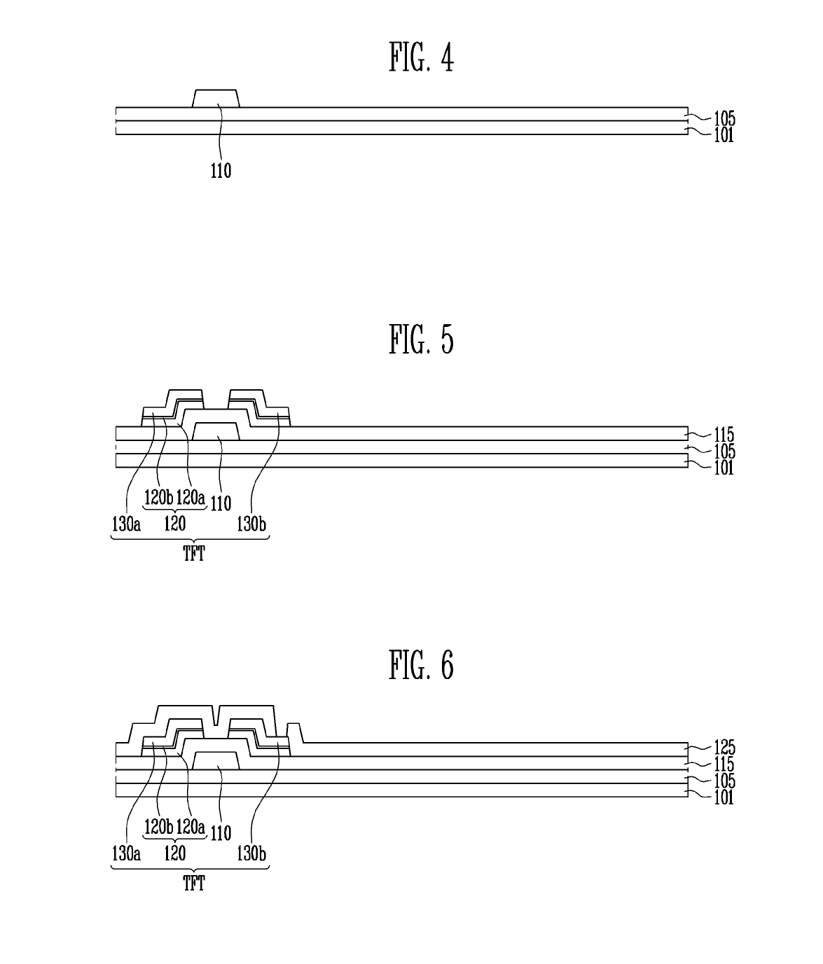

FIGS. 4 to 12 are cross-sectional views sequentially illustrating a manufacturing process of the touch screen integrated display device of FIG. 3.

Referring to FIG. 4, a buffer layer 105 is formed on a first base substrate 101, and a gate electrode 110 is formed on the buffer layer 105.

A material having excellent mechanical strength or size stability may be selected as a material of the first substrate 101 for forming the device. An example of the material of the first base substrate 101 may include a glass plate, a metal plate, a ceramic plate, or plastic (polycarbonate resin, acrylic resin, polyvinyl chloride resin, polyethylene terephthalate resin, polyimide resin, polyester resin, epoxy resin, silicon resin, and fluorine resin).

The buffer layer 105 may be formed for protecting driving elements formed in a subsequent process from impurities, such as alkali ions, discharged from the first base substrate 101. The buffer layer 105 may be formed of a silicon nitride (SiNx), a silicon oxide (SiOx), a silicon oxynitride (SiOxNy), and the like, and may be omitted according to a material of the first base substrate 101.

The gate electrode 110 may be formed of a single kind or several kinds of metal, or an alloy thereof. Particularly, the gate electrode 110 may be formed as a single layer of one or a mixture of ones selected from the group consisting of molybdenum (Mo), tungsten (W), aluminum neodymium (AlNd), titanium (Ti), aluminum (Al), silver (Ag), and an alloy thereof, or may be formed in a multiple-layer structure of molybdenum (Mo), aluminum (Al), or silver (Ag) that is a low-resistance material to reduce resistance of the wire.

Referring to FIG. 5, a gate insulating layer 115 is formed on an entire surface of the first base substrate 101, on which the gate electrode 110 is formed. Next, a semiconductor layer 120, a source electrode 130a, and a drain electrode 130b are formed on the gate insulating layer 115.

The gate insulating layer 115 is formed as a single layer or a laminated structure including one or more inorganic insulating layers, such as a silicon oxide layer, a silicon oxynitride layer, a silicon nitroxyde layer, a silicon nitride layer, and a tantalum oxide layer.

The semiconductor layer 120, the source electrode 130a, and the drain electrode 130b may be formed by sequentially forming an amorphous silicon material layer, an impurity amorphous silicon material layer, and a conductive layer on the gate insulating layer 115, and then patterning the layers by a mask process.

The amorphous silicon layer configures the semiconductor active layer 120a of the semiconductor layer 120, and the impurity amorphous silicon layer configures the ohmic contact layer 120b of the semiconductor layer 120.

The source electrode 130a and the drain electrode 130b may be formed of a conductive material, for example, a metal. Each of the source electrode 130a and the drain electrode 130b may be formed of a single metal, but may be formed of two or more kinds of metal or an alloy of two or more kinds of metal. Further, each of the source electrode 130a and the drain electrode 130b may be formed as a single layer or a multi-layer.

The gate electrode 110, the semiconductor layer 120, the source electrode 130a, and the drain electrode 130b configure a thin film transistor TFT.

Referring to FIG. 6, a passivation layer 125 is formed on an entire surface of the first base substrate 101 on which the thin film transistor TFT is formed. The passivation layer 125 may include at least one film. For example, the passivation layer 125 may include an inorganic passivation layer and an organic layer disposed on the inorganic passivation layer. The inorganic passivation layer may include at least one of a silicon oxide and a silicon nitride. Further, the organic layer may include at least one of acryl, polyimide (PI), polyamide (PA), and benzocyclobutene (BCB). The passivation layer 125 includes an opening exposing a part of the drain electrode 130b to the outside or to other layers.

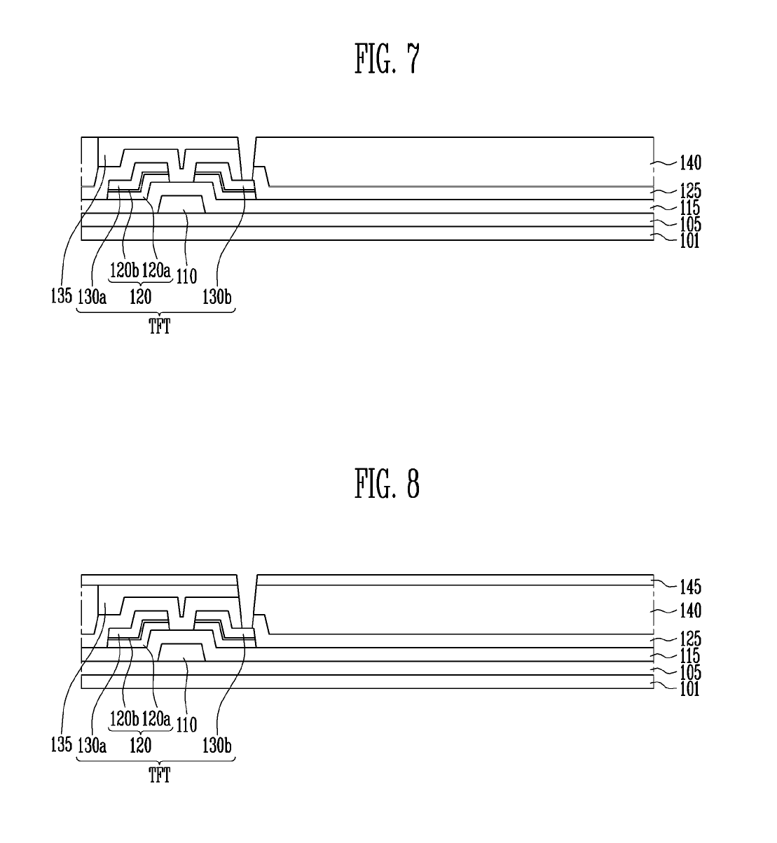

Referring to FIG. 7, a black matrix 135 overlapping the thin film transistor TFT is formed by applying a black matrix material layer formed of an organic composite including carbon black and the like onto the entire surface of the first base substrate 101 on which the passivation layer 125 is formed and patterning the black matrix material layer.

Further, a color filter 140 is formed in a portion in which the black matrix 135 is not formed by applying a colored material layer formed of a photosensitive resin material, in which pigment is dispersed, and patterning the colored material layer.

Referring to FIG. 8, a planarizing layer 145 is formed on the black matrix 135 and the color filter 140. The planarizing layer 145 is patterned to include an opening corresponding to the opening provided in the passivation layer 125. Here, the planarizing layer 145 may be transparent and include an organic passivation layer for easing and planarizing a curve of a lower structure.

Referring to FIG. 9, a first electrode 150 electrically connected with a drain electrode 130b of the thin film transistor TFT through the opening is formed by forming a conductive layer on the entire surface of the first base substrate 11 on which the planarizing layer 145 is formed, and patterning the conductive layer. The first electrode 150 may be formed of a transparent metal material, such as an indium-tin-oxide (ITO) or an indium-zinc-oxide (IZO).

A first alignment layer 160 for pretilting liquid crystal molecules of the liquid crystal layer 300 (see FIG. 3) is formed on the entire surface of the first base substrate 101 on which the first electrode 150 is formed.

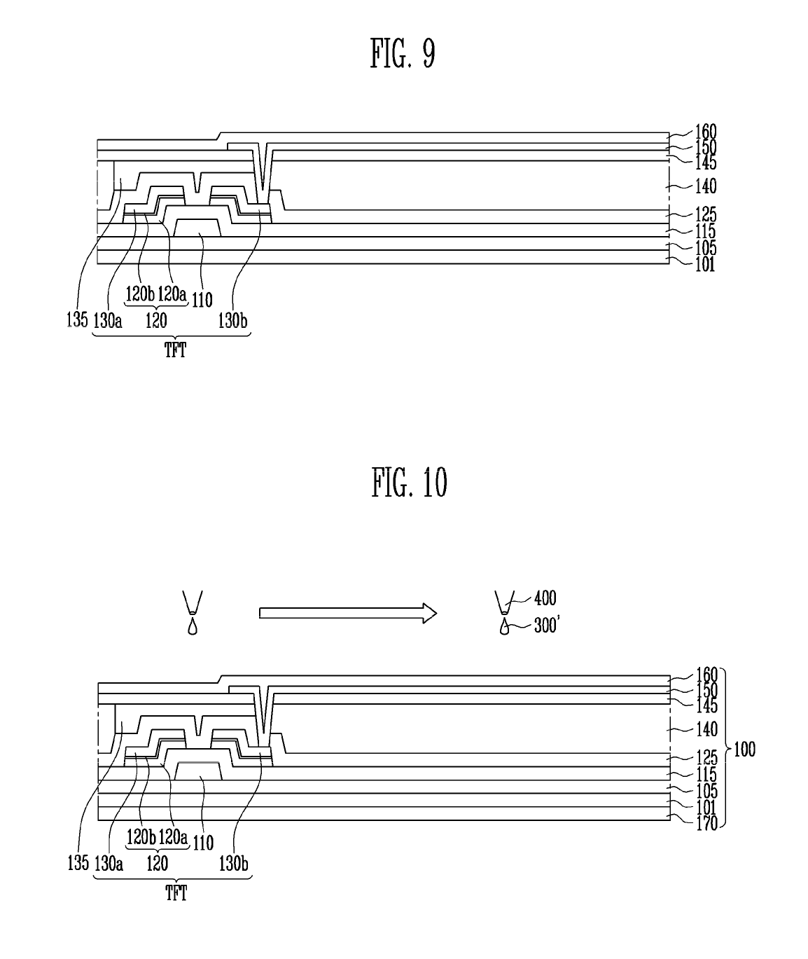

Referring to FIG. 10, a polarizing plate 170 is formed on a rear or bottom surface of the first base substrate 101. The first base substrate 101, the structures disposed on the first base substrate 101, and the polarizing plate 170 configure a first substrate 100 in the touch screen integrated display device according to the exemplary embodiment of the present disclosure.

A liquid crystal 300′ is dropped on the first substrate 100 by using a nozzle 400 and the like. A dispenser and the like may be used as equipment for dropping the liquid crystal 300′ on the first substrate 100.

Referring to FIG. 11, a second substrate 200 including a second base substrate 201, a conductive pattern 210 formed on the second base substrate 201, an insulating layer 220 formed on the conductive pattern 210, a second electrode 230 formed on the insulating layer 220, and a second alignment layer 240 formed on the second electrode 230 is provided.

The second base substrate 201 may be formed of the same material as that of the first base substrate 101.

The conductive pattern 210 includes a plurality of fine patterns 210a formed in parallel in a first direction (for example, a row direction), and a metal pattern 210b positioned around the plurality of fine patterns 210a.

The plurality of fine patterns 210a and the metal pattern 210b are formed of the same conductive material. The plurality of fine patterns 210a may serve as a Wire Grid Polarizer (WGP), which allows only specific polarized light in an electromagnetic wave (for example, visible light) to pass through during an image display period of the touch screen integrated display device 10 according to the exemplary embodiment of the present disclosure.

The metal pattern 210b overlaps the thin film transistor TFT and may serve as a light blocking unit that blocks light passing through the thin film transistor TFT from moving to the second substrate 200.

Further, the metal pattern 210b may serve as a touch receiving electrode detecting a touch position during an image non-display period.

The insulating layer 220 may include any one selected from an inorganic insulating material and an organic insulating material. The inorganic insulating material may include at least one of a silicon oxide and a silicon nitride. The organic insulating material may include at least one of acryl, polyimide (PI), polyamide (PA), and benzocyclobutene (BCB).

The second electrode 230 may be formed of a transparent conductive material. The second electrode 230 may be formed of a conductive metal oxide, such as an indium tin oxide (ITO), an indium zinc oxide (IZO), and an indium tin zinc oxide (ITZO). The second electrode 230 may be used as a common electrode during an image display period when an image is displayed, and used as the touch driving electrode during the image non-display period when no image is displayed.

The second alignment layer 240 faces a first alignment layer 160 of the first substrate 100 with the liquid crystal layer 300 interposed therebetween.

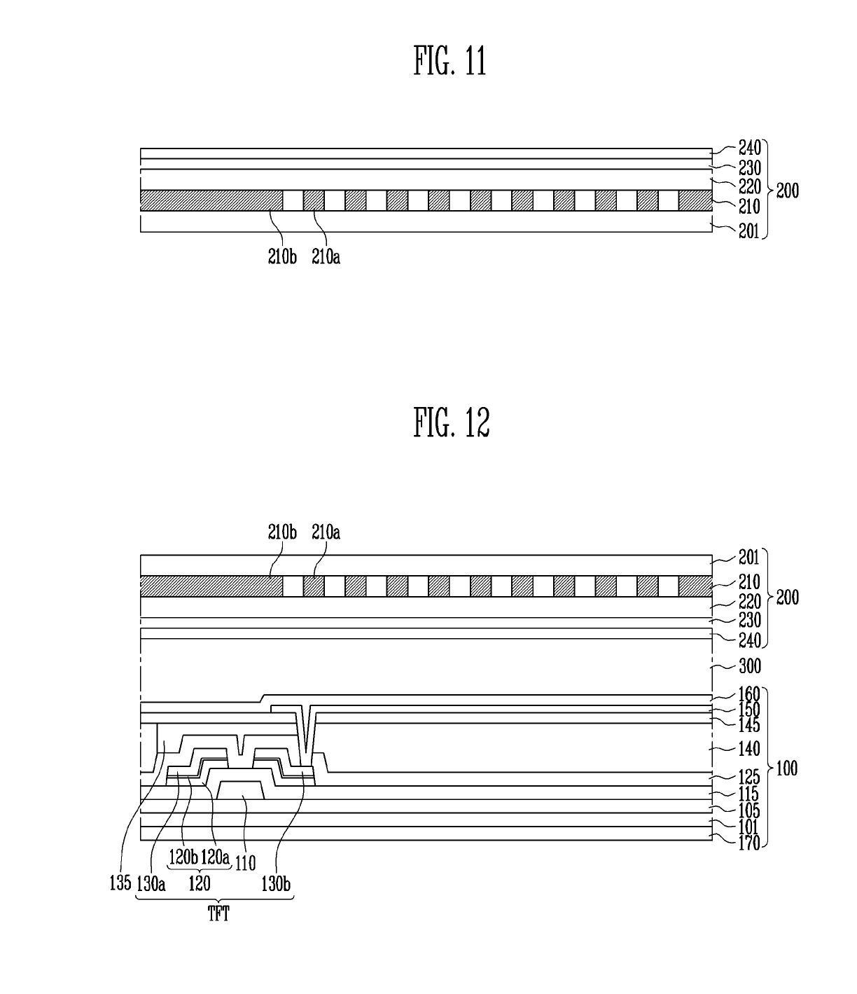

The first substrate 100, onto which the liquid crystal 300′ is applied, is bonded to the second substrate 200. Accordingly, a liquid crystal layer 300 illustrated in FIG. 12 may be formed between the first substrate 100 and the second substrate 200.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the following claims.

What is claimed is:

1. A display device integrated with a touch screen, comprising:
a first base substrate including a plurality of pixel areas;
a second base substrate facing the first base substrate;
a thin film transistor disposed on the first base substrate;
a first electrode connected with the thin film transistor;
a second electrode facing the first electrode on the second base substrate and including a plurality of patterns spaced apart from each other by a predetermined distance in a column direction; and
a conductive pattern disposed between the second base substrate and the second electrode, and including a plurality of patterns spaced apart from each other by a predetermined distance in a row direction crossing the column direction,
wherein each of the plurality of patterns provided in the conductive pattern includes a plurality of fine patterns formed of a wire grid polarizer and a metal pattern disposed around the plurality of fine patterns.

2. The display device of claim 1, wherein the second electrode is configured to receive a common voltage during an image display period of the plurality of pixel areas, and to receive a touch driving signal during an image non-display period of the plurality of pixel areas.

3. The display device of claim 1, wherein the conductive pattern includes an opaque conductive material.

4. The display device of claim 1, wherein the plurality of fine patterns overlaps the pixel area.

5. The display device of claim 1, wherein the metal pattern overlaps the thin film transistor.

6. The display device of claim 1, further comprising:
an insulating layer disposed between the second electrode and the conductive pattern.

7. The display device of claim 6, wherein the insulating layer comprises any one selected from an inorganic insulating material and an organic insulating material.

8. The display device of claim 1, further comprising:
a liquid crystal layer disposed between the first electrode and the second electrode; and
a color filter layer disposed under the liquid crystal layer on the first base substrate, and configured to transmit light of a specific color by filtering light passing through the first base substrate.

9. The display device of claim 1, further comprising:
a liquid crystal layer disposed between the first electrode and the second electrode; and
a color filter layer disposed between the conductive pattern and the second base substrate on the second base substrate.

10. The display device of claim 9, wherein the color filter layer comprises a quantum dot.

11. A method of manufacturing a display device integrated with a touch screen, the method comprising:
providing a first base substrate including a plurality of pixel areas and one or more thin film transistors formed in each of the plurality of pixel areas;
forming a first electrode connected with the thin film transistor on the first base substrate;
providing a second base substrate facing the first base substrate;
forming a conductive pattern including a plurality of patterns spaced apart from each other by a predetermined distance in a row direction on the second base substrate; and
forming a second electrode facing the first electrode on the conductive pattern and including a plurality of patterns spaced apart from each other by a predetermined distance in a column direction crossing the row direction,
wherein each of the plurality of patterns provided in the conductive pattern includes a plurality of fine patterns formed of a wire grid polarizer and a metal pattern positioned around the plurality of fine patterns.

12. The method of claim 11, wherein the conductive pattern comprises an opaque conductive material.

13. The method of claim 11, wherein the plurality of fine patterns overlaps the pixel area.

14. The method of claim 11, wherein the metal pattern overlaps the thin film transistor.

15. The method of claim 11, further comprising:
forming an insulating layer between the second electrode and the conductive pattern.

16. The method of claim 15, wherein the insulating layer comprises any one selected from an inorganic insulating material and an organic insulating material.

17. The method of claim 11, wherein the second electrode comprises a transparent conductive material.
